(19) United States
(12) Patent Application Publication
(10) Pub. No.: US 2024/0055929 A1
(43) Pub. Date: Feb. 15, 2024

(54) ELECTRIC MACHINE

(71) Applicant: GENESIS MOTION SOLUTIONS, LP, Wichita, KS (US)

(72) Inventors: Alex Oleg Posatskiy, Langley (CA); Douglas Dane Reelie, Langley (CA)

(21) Appl. No.: 18/269,970

(22) PCT Filed: Jan. 27, 2022
(86) PCT No.: PCT/IB2022/050727

§ 371 Date: Jun. 28, 2023

(30) Foreign Application Priority Data
Jan. 29, 2021 (GB) 2101282.8
Jan. 29, 2021 (GB) 2101284.4

(51) Int. Cl. H02K 5/15; H02K 5/173; H02K 7/08; H02K 7/102; H02K 11/21; H02K 11/24; H02K 21/14

(52) U.S. Cl. CPC H02K 5/15; H02K 5/1732; H02K 7/083; H02K 7/102; H02K 11/21; H02K 11/24; H02K 21/14

(57) ABSTRACT

A radial flux electric machine comprising: a housing; an inner carrier having an inner surface; and an outer carrier spaced apart from the inner carrier by an airgap; wherein the inner carrier is one of: a stator fixedly attached to the housing, and a rotor configured to rotate relative to the stator about an axis, and the outer carrier is the other of: a stator fixedly attached to the housing, and a rotor configured to rotate relative to the stator about an axis; a plurality of electromagnetic elements defining magnetic poles, disposed on the rotor or stator so as to generate a radial flux between the rotor and stator as the rotor rotates; and at least one bearing having an outer bearing surface; wherein the outer bearing surface has a diameter that is at least as large as the inner diameter of the inner carrier.

### RELATED APPLICATIONS

This application claims priority to GB Patent Application No. 2101284.4 filed Jan. 29, 2021 and GB Patent Application No 2101282.8 filed Jan. 29, 2021, which are incorporated herein by reference in their entireties.

### TECHNICAL FIELD

The invention relates to an electric machine, in particular to an electric machine having an auxiliary module.

### BACKGROUND

It is known to provide an electric machine having an inner carrier, an outer carrier and a bearing to support the inner and outer carriers to move in rotation relative to one another. In one known electric machine, the inner carrier has an inner carrier shaft, and a bearing is provided on the inner carrier shaft. The bearing in such an electric machine is substantially smaller than both of the inner carrier (e.g. a rotor) and the outer carrier (e.g. a stator). It is also spaced apart from the inner and outer carriers in an axial direction, in order to avoid heat build-up near the inner carrier and outer carrier interface.

The inventors have identified improvements to such known electric machines.

Elements of the present disclosure also relate to the following background information.

Further, portions of electric machines, in particular the windings thereof, may be delicate and may easily be damaged during assembly of an electric machine. This may place restrictions on the manufacturing process, such as requiring manufacturing to take place in a single location or in a specific order. Further, damage to the electric machine during assembly and may lead to non-functioning electric machines being manufactured. Further, most electric machines are built with a specific purpose in mind, meaning that the electric machines are designed with a limited number of connection points and with a specific loading direction. Such electric machines operate acceptably in their intended role, but a new machine may be required if the role changes. The inventors have realised that an electric machine may be constructed which is more widely applicable, with more flexibility of function and where delicate parts may be protected, such that manufacturability may be improved.

Further still, electric machines, such as electric motors and generators, are usually designed with a specific purpose in mind. Since electric machines are usually designed in this way, a fundamental redesign of the machine may be required when the usage of the machine changes. This redesign may take a significant time and may also require changes in tooling, increasing the cost of the individual electric machines. Further, many electric motors may have a limited number of connection points, restricting the way in which they may be connected to external components. External components may need to be strengthened in order to deal with the higher stresses associated with a lower number of connection points.

Moreover, the functionality of electric machines may vary, as they may require brakes, encoders and similar auxiliary modules in order to carry out their intended function. The provision of such auxiliary modules in known electric machines may require an amount of redesigning of the machine or may increase the footprint of the machine.

The present inventors have sought to address the above issues in the following disclosure.

### SUMMARY OF THE INVENTION

The inventors have identified that by modifying the size of the bearing relative to the inner and outer carriers, an electric machine having improved and structural properties, dimension control, and in particular improved control over an airgap between the inner and outer carriers, can be achieved. Further, this may provide a large interior space, which may be used to incorporate auxiliary modules of the electric machine without increasing the footprint of the machine.

According to a first aspect of the invention, there is provided a radial flux electric machine comprising: a housing; an inner carrier having an inner surface; and an outer carrier spaced apart from the inner carrier by an airgap; wherein the inner carrier is one of: a stator fixedly attached to the housing, and a rotor configured to rotate relative to the stator about an axis, and the outer carrier is the other of: a stator fixedly attached to the housing, and a rotor configured to rotate relative to the stator about an axis; a plurality of electromagnetic elements defining magnetic poles, disposed on the rotor or stator so as to generate a radial flux between the rotor and stator as the rotor rotates; at least one bearing having an outer bearing surface; and an auxiliary module located within a diameter of the inner carrier, the auxiliary module comprising one or more of: a brake configured to brake the motor and/or a sensor configured to sense at least one operational parameter of the motor; wherein the outer bearing surface has a diameter that is at least as large as the inner diameter of the inner carrier.

Each of the inner and outer carriers therefore forms a respective one of a stator fixedly attached to the housing, and a rotor configured to rotate relative to the stator about an axis. By providing an electric machine having an outer bearing surface which has a diameter that is at least as large as the inner diameter of the inner carrier, it is possible to allow the bearing to be located proximate the interface between the inner and outer carriers, allowing for improved dimension control, and control over the relative locations of the inner and outer carriers. An additional advantage of this feature is that, compared to known electric machines, the bearing can be located further from internal locations of the electric machine, which allows the internal volume of the electric machine to be free to accommodate other components.

The outer bearing surface may be aligned with or radially proximate to an inner surface of the outer carrier. The bearing may be disposed radially proximate to both the inner and outer carriers. The bearing may be disposed axially proximate to both the inner and outer carriers. These features have the advantage of providing improved dimension control and stability to the electric machine, specifically to an airgap provided between the inner and outer carriers.

The bearing may be disposed substantially axially outwardly of the inner carrier. The outer carrier may extend axially to a greater extent than the inner carrier. The bearing may be disposed substantially in a corner or in an annular region defined by or between the outer carrier and the inner carrier or surfaces thereof. The outer carrier may have a length in an axial direction from a first end to a second end. The bearing may be disposed wholly within the outer carrier at an axial position between the first end and the second end. The housing may comprise at least one end cover. The end cover, outer carrier, and inner carrier may define an opening in which the bearing is disposed. The inner carrier may comprise an inner carrier shaft. The inner carrier shaft may extend substantially axially from the inner carrier. The bearing may be disposed between the inner carrier shaft and the outer carrier. The end cover, outer carrier, inner carrier and inner carrier shaft may define an opening in which the bearing is disposed. These features have the advantage of providing a structurally robust, easy to manufacture, and compact arrangement.

The ratio of the inner diameter of the outer carrier to the outer diameter of the outer carrier may be at least 0.6, optionally at least 0.7, optionally at least 0.75, optionally at least 0.8. The ratio of the inner diameter of the inner carrier to the outer diameter of the inner carrier may be at least 0.6, optionally at least 0.7, optionally at least 0.75, optionally at least 0.8, optionally at least 0.83. These features have the advantage of providing an electric machine having a free inner diameter, in which other components may be accommodated.

The diameter of the inner surface of the outer carrier may be at least 7 cm, optionally at least 9 cm, optionally at least 10 cm, optionally at least 13 cm, optionally at least 13.3 cm. The diameter of the inner surface of the inner carrier may be at least 4.5 cm, optionally at least 6.5 cm, optionally at least 7.5 cm, optionally at least 10.5 cm, optionally at least 10.8 cm. The distance between the inner surface of the outer carrier and the inner surface of the inner carrier may be at least 12.5 mm. The diameter of the inner surface of the outer carrier minus the diameter of the inner surface of the inner carrier may be at least 2.5 cm. The airgap may have a radial dimension of at least 0.25 mm.

The ratio of the diameter of the outer bearing surface to the airgap radial dimension may be at least 250, optionally at least 500. The ratio of the diameter of the inner surface of the outer carrier to the airgap radial dimension may be at least 250, optionally at least 530.

The bearing may comprise a first bearing at a first axial end of the inner and outer carriers, and/or a second bearing at a second axial end of the inner and outer carriers. This has the advantage of providing a structurally robust electric machine.

The first bearing has an inner diameter, which may be greater than an inner diameter of the second bearing, and may be at least 10% greater than the inner diameter of the second bearing. This may allow a greater internal space at one end of the electric machine, allowing a greater range of auxiliary modules to be provided.

The bearing arrangement may comprise a first bearing at the first axial end of the rotor and the first axial end of the stator and a second bearing at the second axial end of the rotor and the second axial end of the stator. By providing first and second bearings, which are spaced apart, the machine may be made more stable, and the stator and rotor may be disposed between the bearings, which may allow an electric machine to be produced with a reduced radial extent, i.e. a smaller electric machine.

The first and second bearings may be substantially similar and the first and second bearings may each be symmetrical about a respective second symmetry plane perpendicular to the axis. By providing similar bearings and bearings which are symmetrical, the bearings may be interchanged freely and so only a single type of bearing may be required, simplifying manufacture and reducing the number of different parts making up the machine. Overall, this may improve manufacturability.

The inner carrier may comprise an inner carrier shaft having a first axial end proximate a first axial end of the inner carrier and a second axial end proximate a second axial end of the inner carrier. The inner carrier shaft may be asymmetric about a plane perpendicular to the axis of the electric machine. The first axial end of the inner carrier shaft may have a diameter greater than the diameter of the second axial end. This may allow a compact external mechanical connection at one end to external members or devices and an improved interior space for the provision of auxiliary modules. The second axial ends of the inner and outer carriers may therefore comprise external connectors for connection the inner and outer carriers to external members. The connectors may be mechanical connectors.

The inner carrier may be a rotor configured to rotate relative to the stator about an axis. The outer carrier may be a stator fixedly attached to the housing.

The inner carrier may comprise an inner carrier shaft, and the auxiliary module may be located within a cavity within the inner carrier shaft. This may provide a more compact electric machine having further functionality. The auxiliary module may be a brake, an electric brake, a torque measuring device or an encoder.

The auxiliary module may be coupled to the inner and outer carriers. This may allow the auxiliary module to provide a braking function between the two carriers or to measure a relative rotational speed or position between the two carriers.

The auxiliary module may be located within a distance D of the inner carrier. The distance D may be less than a half of the inner diameter of the inner carrier. This may allow the auxiliary module to be covered by an end cover of the electric machine, thereby providing a unitary electric machine with improved functionality.

The inner and outer carriers may each be a rotor or a stator. Where a stator surrounds a rotor, the stator may be considered to be an outer carrier and the rotor may be considered to be an inner carrier. In the reverse arrangement, where the rotor surrounds the stator, the rotor may be considered as an outer carrier and the stator may be considered as an inner carrier. Each of the carriers and their respective end covers which can also be referred to as end shields, their carrier shaft, carrier support and/or carrier frame may collectively form a subassembly of an electric machine, or at least a part thereof. The inner carrier shaft may be referred to as a rotor shaft or a drive shaft.

The electric machine may further comprise an outer auxiliary member fixedly coupled between, and arranged to transfer rotation and/or torque between, the outer carrier assembly and to the at least one auxiliary module.

An auxiliary module may be arranged radially inside both the inner carrier and the outer carrier or within both the inner carrier assembly and the outer carrier assembly. At least one of the one or more auxiliary modules may be disposed within a bore of the inner carrier or of the inner carrier assembly.

The electric machine may also comprise an inner auxiliary member coupled between, and arranged to transfer rotation and/or torque between, the inner carrier assembly and the auxiliary module.

With such an arrangement, an auxiliary module arranged inside the inner carrier, e.g. the rotor, may be able to control and/or sense relative movement between a rotor and a stator, such as to carry out a braking or measurement function, while providing a compact arrangement by being positioned inside a hollow rotor and/or stator of the assembly. The inner auxiliary member and/or the outer auxiliary member can therefore be arranged to transfer rotation and/or torque between the stator and/or rotor assemblies and the auxiliary module(s).

The outer auxiliary member may be coupled to a first axial end of the outer carrier assembly and may extend axially towards a second axial end of the outer carrier assembly within the inner carrier assembly. The outer auxiliary member may extend axially along the inner carrier assembly, at a location radially inside the inner carrier assembly. In this arrangement, the auxiliary module may be located axially centrally or toward the second axial end of the inner carrier, providing a more axially compact arrangement, and allowing more than one auxiliary module to be positioned within the inner carrier.

Similarly, the inner auxiliary member may be coupled to a first axial end of the inner carrier assembly and may extend axially towards a second axial end of the inner carrier assembly within the inner carrier assembly. The inner auxiliary member may therefore comprise a portion that is radially within the inner carrier assembly and which extends axially along an axis of the inner carrier assembly. This arrangement may provide similar advantages to those discussed above.

The outer auxiliary member may extend axially at least partially within the inner auxiliary member. In this case, where the inner carrier assembly may be radially inside the outer carrier assembly, this may allow an auxiliary module to be accessed from the same axial end by both the inner carrier auxiliary member and the outer auxiliary member, providing a more easily configurable arrangement. The inner auxiliary member may extend axially at least partially within the outer auxiliary member.

At least one auxiliary module may be arranged proximate a first axial end of the inner carrier assembly. This may allow the auxiliary module to be more easily coupled to and decoupled from the remainder of the electric machine.

The electric machine may therefore be arranged such that the auxiliary module is connected to the outer carrier assembly and to the inner carrier assembly at a same end of the electric machine, or at different ends of the electric machine. Such connection may be via one or more of the described outer auxiliary member and/or inner auxiliary member.

The inner auxiliary member and/or the outer auxiliary member may extend through at least one auxiliary module. In the case that there is more than one auxiliary module, this may allow improved access to the inner auxiliary member and outer auxiliary member for further auxiliary modules. This may further allow a radially facing interface between the inner auxiliary member and the outer auxiliary member to enable an auxiliary module such as a brake or encoder, to be located at this interface.

The outer auxiliary member may extend in the same direction as the inner auxiliary member, within the inner auxiliary member. The outer auxiliary member and inner auxiliary member may therefore have portions which are formed as parallel, coaxial cylinders.

The portion of the outer auxiliary member within the inner carrier assembly may have a first sub-portion proximate the second axial end of the outer carrier assembly and a second sub-portion proximate the first axial end of the outer carrier assembly, the first sub-portion having a greater diameter than the second sub-portion. The outer auxiliary member may therefore have a portion that has an enlarged inner diameter, for accommodating larger auxiliary modules.

The first axial end of the outer carrier assembly and the second axial end of the inner carrier assembly may be arranged at the same axial end of the electric machine.

At least one auxiliary module may be arranged inside the inner auxiliary member and/or the outer auxiliary member. This may provide a more compact arrangement overall and may allow a smaller auxiliary module to be used and efficiently accommodated.

The electric machine may comprise at least two auxiliary modules. The auxiliary modules may comprise a brake for braking a motion of the rotor relative to the stator. The auxiliary modules may comprise an encoder for detecting position and/or rotation of the rotor relative to the stator.

A subassembly of the electric machine may comprise: a plurality of soft magnetic posts; a plurality of windings arranged to magnetise the posts; a first potting compound at an axial end of the soft magnetic posts, the potting compound containing at least a portion of the windings; and a first end shield arranged to cover an axial end of the potting compound opposite the posts and an inner or outer radial surface of the potting compound, wherein the first end shield comprises an arcuate or cylindrical surface arranged to couple the subassembly to a second subassembly of the electric machine, the second subassembly being rotatable relative to the subassembly about an axis. The subassembly may be a carrier having any of the features of a carrier described herein.

The end shield may provide protection to the potting compound and to the portion of the windings within the potting compound. Further, the end shield may be used as a mould such that the potting compound may be injected into the end shield and subsequently solidified. The protection afforded by the end shield may allow the subassembly of the electric machine to be manufactured separately from the rest of the electric machine and transported with a reduced chance of damage to the internal components of the subassembly.

An inner radius of the arcuate or cylindrical surface of the first end shield may be equal to an inner radius of the soft magnetic posts. This may allow the soft magnetic posts and the end shields to be machined simultaneously and may thereby allow a decreased tolerance stack up, allowing a smaller air gap between the subassembly and the second subassembly of the electric machine.

The first end shield may comprise a connector arranged to connect the subassembly or carrier to an external part. The connector is a mechanical connector. The end shield may thereby provide a solid fixing point for the external part so that the connection may be made without contacting the internal parts of the subassembly or carrier.

The connector may comprise a plurality of holes tapped into the first end shield. The connectors may each have a plurality of screw holes arranged to couple the rotor or stator to an external part. Screw holes, or hole taps, may be a simple and widely used way to connect the electric machine to an external part. They may also provide a connection means which does not increase the size or weight of the electric machine, meaning that redundant connectors may be provided without size and weight drawbacks.

The screw holes may be distributed about the axis in a rotationally symmetrical arrangement. The rotationally symmetrical arrangement may be arranged in a greater range of orientations, and in particular the rotor may be fixed to an external part without being rotated to a particular position beforehand. This may also allow external connectors of the electric machine (such as power connectors and data transmission connectors) to be connected to internal portions of the electric machine at a greater range of angles. Overall, connectivity of the electric machine may be improved.

The subassembly may further comprise a frame disposed radially outside or radially inside the soft magnetic posts, and the first end shield may be fixed to the frame. Therefore, the subassembly may be further protected. The frame and the end shields may be separate components and may be fixed together during manufacture. This may allow an easier manufacture, allowing access to the windings of the subassembly during manufacture, the protective end shield and frame being applied later. As electric machines, particularly radial flux electric machines, may vary in axial length while maintaining substantially similar radial dimensions, this may also allow the same end shields to be used for a range of different electric machines.

The subassembly may further comprise a second potting compound at a second axial end of the soft magnetic posts, the second potting compound containing at least a second portion of the windings; and a second end shield, arranged to cover an axial end of the second potting compound opposite the stator posts and an inner or outer radial surface of the second potting compound. The second potting compound and second end shield may provide a substantially symmetrical rotor and stator arrangement, which may provide a greater range of functionality as the subassembly or carrier being symmetrical may allow components to be joined in a greater range of ways.

The second end shield may be substantially similar to the first end shield. The first and second end shields may therefore be formed as identical end shields, using a single tool. The two end shields may therefore be oriented differently during assembly.

The first end shield and second end shield may be arranged to be symmetrical about a first symmetry plane perpendicular to the axis. The second end shield may therefore be a mirror image of the first end shield about the first symmetry plane.

Either carrier may be a stator and the surface of the end shield may be arranged to couple to a bearing assembly or a rotor.

The soft magnetic posts, the windings and/or the potting compounds may have an exposed surface adjacent the arcuate or curved surface of the end shield. This may allow the subassembly to couple to a second subassembly, such as a rotor, more easily.

As the exposed surface may be a radially inner surface of the outer carrier, the probability of damage occurring to the exposed surface may be lower.

As described above, such an electric machine may be manufactured with greater flexibility and may provide greater protection to internal components.

The bearing arrangement may comprise a first bearing assembly disposed radially adjacent the first end shield and a second bearing assembly radially adjacent the second end shield. The end shields may thereby provide convenient means for coupling the carrier having the end shields to the bearing arrangement and so may provide a more simple construction of the electric machine where the carriers are to be joined.

The bearing arrangement and the end shield may have the same thermal expansion coefficient. By providing the bearing arrangement and end shields with the same thermal expansion coefficient, encroachment of internal components upon each other when the motor heats and cools may be prevented, as the end shields and bearing arrangement may be radially adjacent and so may move components fixed to them radially by the same amount due to heating. In some cases, the end shields and the bearing arrangement may be formed from the same material.

The rotor may comprise a plurality of magnetic poles disposed on an inner rotor shaft, and the inner rotor shaft may have the same thermal expansion coefficient as the first and second bearing assemblies in first and second regions, the first and second regions of the inner rotor shaft being radially adjacent to the respective first and second bearing assemblies. In this way, a consistent line or annulus of parts having the same thermal expansion coefficient may be provided between an inner and an outer diameter of the electric machine. This may allow the air gap of the electric machine to be more consistent during heating and cooling, allowing reduced tolerances within the design of the electric machine.

The bearing arrangement may have a first coefficient of thermal expansion and the end shield may have a second coefficient of thermal expansion, and the first and second coefficients of thermal expansion are within 60% of each other. Alternatively, the first and second coefficients of thermal expansion may be the same.

In this case, the first and second coefficients of thermal expansion may be sufficiently similar that component clash due to heating may be avoided, while maintaining some flexibility of the materials used so that different materials may be used for the end shields and bearing arrangement, such as different types of steel.

The electric machine may comprise a plurality of connectors, which are mechanical connectors, the plurality of connectors comprising: a first stator connector at a first axial end of the stator assembly; a second stator connector at a second axial end of the stator assembly substantially similar to the first stator connector; a first rotor connector at a first axial end of the rotor assembly; and a second rotor connector at a second axial end of the rotor assembly substantially similar to the first rotor connector.

By providing first and second connectors on both of the stator and rotor which are substantially similar, the electric machine may be connected in different orientations, allowing greater design flexibility. Further, the same electric machine may be used in different, mirrored arrangements, such as in right and left arms of a robot. The symmetry of the electric machine may also allow the machine to be connected within a joint, such as within an elbow joint. Overall, this provides a machine applicable to a greater range of situations.

The electric machine may further comprise an auxiliary module having auxiliary module connectors coupled to the first rotor connector at the first end of the rotor assembly and to the first stator connector at the first axial end of the stator assembly; wherein the second rotor connector and the second stator connector are configured to be coupleable to the auxiliary module connectors.

Where ancillary features, also referred to as auxiliary modules, such as brakes or encoders, are to be connected to the electric machine, they may be connected at either axial end, improving the range of applications for which the electric machine may be used. In some cases, an ancillary feature may be connected at a first end and an external part to be moved may be connected at an opposite end. Therefore, ancillary features may be incorporated into the electric machine without affecting connectivity to external parts.

The electric machine may further comprise external mechanical connectors for coupling the inner carrier and the outer carrier to external members mechanically. The external connectors may be arranged at the second axial end of the outer carrier assembly and the second axial end of the inner carrier assembly. The connections for the auxiliary module and for external parts may therefore be separate, meaning that electric machines may be coupled to external parts in the same way regardless of whether the electric machine is provided with auxiliary modules.

The second stator connector may be substantially symmetrical to the first stator connector and the second rotor connector may be substantially symmetrical to the first rotor connector.

The inner and/or outer carrier may each have a substantially symmetrical envelope about a first symmetry plane perpendicular to the axis. The envelope may also be referred to as a footprint or silhouette and may be the space taken up by the rotor or stator. Specifically, it may be the space taken up by the electromagnetically active part of the carriers (i.e. permanent magnets, ferromagnetic elements, electromagnets, windings etc.). By providing a substantially symmetrical envelope or footprint, the overall arrangement of the electric machine may be symmetrical and so may be employed in mirrored applications without the machine being altered.

The carriers may each have a substantially symmetrical internal structure about the first symmetry plane. While some machines may have specific loading directions, such as a drive shaft extending out of a first axial end, from which drive must be taken, a machine having a symmetrical internal structure may be loaded in a greater range of ways and may therefore be used in a greater range of applications.

The bearing arrangement may be symmetrical about a first symmetry plane perpendicular to the axis. In this way, the bearing arrangement may be assembled within the electric machine without an orientation of the bearing arrangement being specified, so that the assembly may be made simpler. Further, if the bearing arrangement may be loaded in either direction, then the electric machine may be usable in a greater range of applications.

The rotor assembly may comprise a rotor shaft fixed to the rotor, and the first and second rotor connectors may be disposed on axial ends of the rotor shaft. The rotor shaft may be hollow. By providing connectors on an end of a hollow rotor shaft, the force on each connector may be lower as the connectors may be arranged at a greater radial distance from the axis of rotation. Further, the parts count may be reduced if the connectors are integrated within the rotor shaft. The rotor shaft may also act to strengthen the rotor.

The auxiliary module may be coupled to the first and/or second stator connector and the first and/or the second rotor connector. The auxiliary module may be an electric brake, a torque measuring device or an encoder. The auxiliary module may increase the functionality of the electric machine. By providing an auxiliary module, the electric machine may be braked or may have its rotational position or speed measured.

The auxiliary module may be arranged radially inside the rotor and/or the stator. Optionally, the auxiliary module may be arranged within a cavity inside the inner carrier shaft. This may allow the auxiliary module to be provided without altering the overall footprint of the machine, allowing a more compact machine to be formed and allowing a machine having a range of different functionalities to be interchanged in the same location.

The first stator connector may be at a first distance from the axis; the second stator connector may be arranged at a second distance from the axis; the first rotor connector may be arranged at a third distance from the axis; and the second rotor connector may be arranged at a fourth distance from the axis; the first distance may be less than 10% greater than the second distance and the third distance may be less than 10% greater than the fourth distance. With such an arrangement, the first and second connectors of the rotor and stator may be sufficiently similar that they may be used interchangeably, without such a high design tolerance being placed on the motor.

Each of the stator and rotor connectors may comprise a plurality of connectors distributed about the stator and rotor assemblies respectively. By using a plurality of connectors, the force on each individual connector may be reduced and so the resilience of the electric machine may be improved.

The pluralities of connectors may each be distributed in a rotationally symmetrical arrangement. This may provide an even loading to the connectors as well as allowing the electric machine to be connected in a greater range of orientations.

The electric machine may comprise: an outer carrier extending from a first axial outer carrier end to a second axial outer carrier end; an inner carrier arranged radially inside the outer carrier and being movable relative to the outer carrier about an axis; a housing assembly containing the inner and outer carriers; an electrical connector mounted to the housing assembly and arranged to transfer power and/or electrical signals to and/or from the electric machine, the electrical connector being arranged between the first and second axial outer carrier ends; a first channel arranged to contain electrical cables extending from the electrical connector and passing within the housing assembly past the inner and/or outer carrier axially outside the first axial outer carrier end, to a first axial outer end of the housing assembly; and a second channel arranged to contain electrical cables extending from the electrical connector and passing within the housing assembly past the outer carrier axially outside the second axial outer carrier end, to a second axial outer end of the housing assembly.

With such an arrangement, the electric machine may provide a convenient path for arranging cables between an internal auxiliary module and an outer electrical connector.

The first channel may be arranged such that the electrical connector is electrically connectable to an auxiliary module arranged radially within the inner carrier via the first channel; and the second channel may be arranged such that the electrical connector is connectable to an auxiliary module arranged radially within the inner carrier via the second channel. In this way, an auxiliary module may be coupled via either axial end of the electric machine, meaning that the drive may be taken from the rotor at either axial end without preventing communication between the auxiliary module and the electrical connector arranged at a radially outer location.

The first channel may extend past the inner carrier at a location axially outside a first axial inner carrier end of the inner carrier and/or the second channel may extend past the inner carrier at a location axially outside a second axial inner carrier end of the inner carrier. With such an arrangement, communication may be provided between the electrical connector and an auxiliary module without interference with the moving parts of the machine.

The electric machine may further comprise an auxiliary module arranged radially inside the inner carrier and an electrical cable extending from the electrical connector to the auxiliary module via the first channel. The electric machine may also further comprise a shaft extension coupled to the inner carrier, and the shaft extension may close the second channel.

The electric machine may comprise: an outer carrier extending from a first axial outer carrier end to a second axial outer carrier end; an inner carrier arranged radially inside the outer carrier and being movable relative to the outer carrier about an axis; a housing assembly containing the inner and outer carriers; an electrical connector mounted to the housing assembly and arranged to transfer power and/or electrical signals to and/or from the electric machine, the electrical connector being arranged between the first and second axial outer carrier ends; a first channel arranged to contain electrical cables extending from the electrical connector and passing within the housing assembly to the first axial outer carrier end; and a second channel arranged to contain electrical cables extending from the electrical to the second axial outer carrier end. There is therefore provided an electric machine which may have a symmetrical internal structure, allowing the same machine to be used in a greater range of applications.

The radial flux electric machine may further comprise an outer carrier housing; the first channel may extend through the outer carrier housing at a location axially outside the first axial outer carrier end; and the second channel may extend through the outer carrier housing at a location axially outside the second axial outer carrier end. The channels may therefore route cables from axially outer ends of the outer carrier, which may be convenient for providing power to the windings of the carrier, to an axially central electrical connector, which may be convenient for external connections.

The radial flux electric machine may further comprise an electrical cable extending from the electrical connector to the outer carrier via the first or second channel.

According to a second aspect of the invention, there is provided a sub-assembly for a radial flux electric machine comprising: a housing; an inner carrier having an inner surface; and an outer carrier radially spaced apart from the inner carrier by an airgap; wherein the inner carrier is a first one of: a stator fixedly attached to the housing, and a rotor configured to rotate relative to the stator about an axis, and the outer carrier is the other one of: the stator fixedly attached to the housing, and the rotor configured to rotate relative to the stator about an axis; a plurality of electromagnetic elements defining magnetic poles, disposed on the rotor or stator so as to generate a radial flux between the rotor and stator as the rotor rotates; and wherein the ratio of the inner diameter of the outer carrier to the outer diameter of the outer carrier is at least 0.6; and wherein the ratio of the inner diameter of the inner carrier to the outer diameter of the inner carrier is at least 0.6.

With such an arrangement, the sub-assembly may be used within an electric machine and may provide an internal cavity within the electric machine for receiving auxiliary modules.

It will be understood that optional aspects described above with respect to the first aspect may also be applied to the second aspect.

### BRIEF DESCRIPTION OF THE DRAWINGS

FIG. 1 shows a general view of an electric motor.

FIG. 2 shows a cutaway view of the electric motor of FIG. 1 along plane A-A-A-A;

FIG. 3a shows a cross section of an electric machine assembly;

FIG. 3b shows a cross section of a second electric machine assembly;

FIG. 4a shows an end view of a first electric machine;

FIG. 4b shows a radial cross section of the first electric machine;

FIG. 5 shows a radial cross section of a second electric machine;

FIG. 6 shows a radial cross section of a third electric machine;

FIG. 7 shows a dimensioned radial cross section of the second electric machine;

FIG. 8 is a flow chart illustrating a method of constructing an electric machine;

FIG. 9 shows a cutaway view of the electric motor of FIG. 1 along plane B-B-B-B;

FIG. 10 shows a radial cross section of a further electric machine; and

FIG. 11 shows a dimensioned radial cross section of the further electric machine.

### DETAILED DESCRIPTION

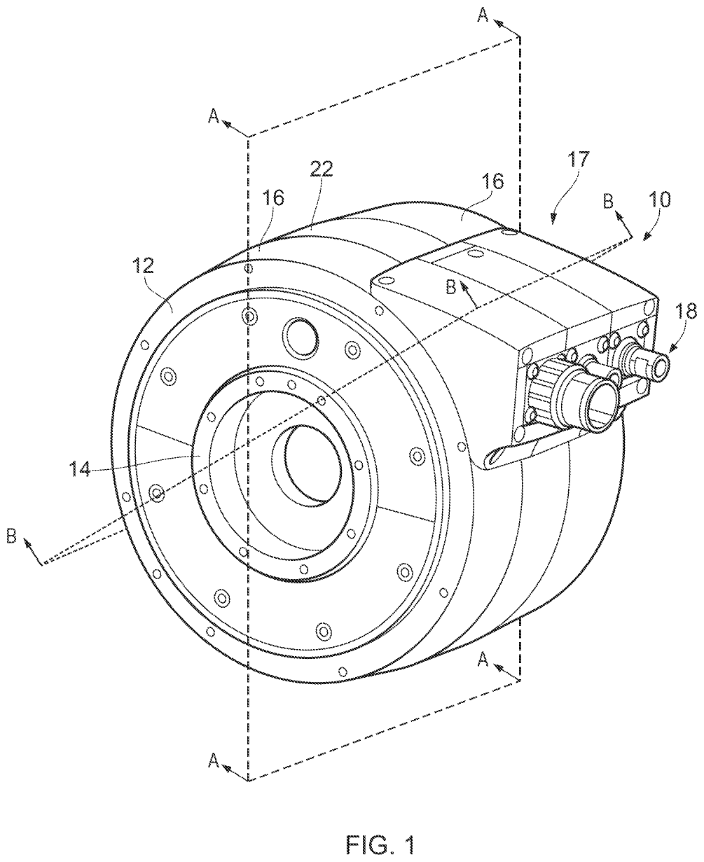

FIG. 1 shows an electric machine assembly, which in this case is a motor assembly 10. It will be understood that the electric machine assembly may alternatively be a generator having substantially similar features. The motor is provided with first and second electromagnetic carriers, for carrying electromagnetic components of the machine in rotation relative to one another. These carriers are therefore rotatable relative to one another about a common axis within the electric machine. A first of the carriers may be an outer carrier. The outer carrier may be arranged radially outward of the second carrier. The inner carrier may be arranged radially inward of the outer carrier. The motor assembly 10 has a connection plate 12, which has a plurality of connections for connecting the outer carrier. The outer carrier may be the stator and may be to a fixed external part via the connection plate 12. The motor assembly 10 also has an inner connection plate 14, which is for fixing an inner carrier, such as the rotor of the motor 10 to an external part intended to be moved. This may be termed a rotor connection plate 14. There is also provided an internal cavity inside the rotor connection plate 14, and the internal cavity may extend through the axis of the motor 10, such that wires may pass through the centre of the motor. The internal cavity may also act as a heat sink to transfer heat away from the motor.

On an outer surface of the motor assembly 10 there is a housing, which is formed of axially outer housing sections 16 and central housing section 22. The housing sections 16, 22 may protect internal parts of the motor assembly 10 from external forces and may thereby improve the resilience of the motor assembly 10.

The motor assembly 10 has electrical and data connectors 18, which may be connected to a power source so that the motor may be powered and the electrical and data connectors 18 may also be used for data transfer, such as providing a command to a motor to actuate a brake or for the motor to output position or speed data from an encoder or torque data from a torque sensor.

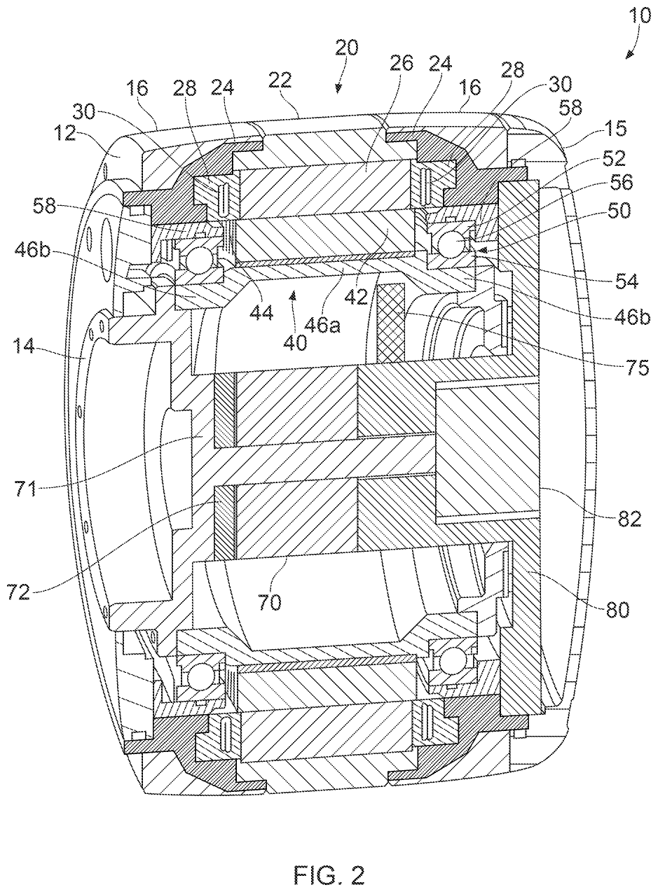

FIG. 2 shows a cutaway view of the electric motor assembly 10 taken along plane A-A-A-A. The motor assembly 10 has an outer carrier assembly 20, which may be a stator assembly 20. The outer carrier assembly 20 has a plurality of magnetic posts 26, which may be formed from a soft magnetic material, such as soft iron, and which may be energised by windings 30, wrapped around and/or between the magnetic posts 26. The outer carrier may be a stator of the electric machine and the magnetic posts 26 may be stator posts. The windings 30 may be loops of a conductor such as copper wire. At either or both axial ends of the stator posts 26, the windings 30 are within a potting compound 28. A potting compound 28 holds the portions of the windings 30 situated therein in place and may also act to protect the windings 30 and to provide electrical insulation to the windings 30. The potting compound 28 may also conduct heat away from the windings 30. The portions of the potting compound 28 at the axial ends of the stator posts 26 may be referred to as a single potting compound or as separate potting compounds. It will be understood that, although the portions may be referred to as separate potting compounds, they may be formed from the same type of material.

The potting compound 28 is surrounded by an end shield 24 on either end. The end shield 24 covers an axial end of the potting compound 28 opposite the stator posts 26 and also extends around an outer surface of, or at least partially envelopes, the potting compound 28, to partially cover a radially inner surface of the potting compound 28. The portion of the end shield 24 covering the radially inner surface of the potting compound 28 may provide a surface for engaging with another subassembly, such as a bearing, meaning that the potting compound may be protected from wear due to contact with other parts of the motor. The potting compound 28 may also be protected on a radially outer side by the end shield 24, which may extend over the potting compound between the axially outer end of the potting compound 28 and the stator posts 26. In such cases, the end shield 24 may protect the potting compound 28 when the outer sections 16 of the motor assembly 10 are not applied, such as during intermediate stages of the manufacture of the motor assembly 10. The two end shields 24 may overlap and engage with the central portion 22 of the housing of the motor assembly. The end shields 24 and central portion 22 may therefore provide a housing protecting the radially outer surface of the stator assembly 20.

The stator posts 26 may define the stator and the stator may extend between a first axial end of the stator and a second axial end of the stator. The potting compound 28 may be located at both of the first and the second axial ends.

The motor assembly 10 may also comprise a rotor assembly 40. The rotor assembly 40 can comprise an inner electromagnetic carrier. The inner carrier may comprise a plurality of electromagnetic elements defining magnetic rotor poles 44 and permanent magnets 42. The permanent magnets 42 and rotor poles 44 may be arranged in an alternating arrangement and the rotor poles 44 may be formed of a ferromagnetic material, such that the rotor assembly 40 may provide alternating magnetic poles around its circumference. The rotor assembly 40 may be separated from the stator assembly 20 by an air gap, which is not visible in this view. This can provide a magnetic air gap between poles 44 and 26.

On a radially inner side of the rotor poles 44, there is a drive shaft 46, having a central drive shaft portion 46a arranged to couple to the rotor poles 44, or to a back-iron connected to the rotor poles 44. Engagement between the rotor poles 44 and the drive shaft 46 may be keyed or may be an interference fit. The central portion 46a of the draft shaft may also act to reinforce the soft magnetic material of the rotor assembly 40 and may thereby improve the strength of the assembly carrying the rotor poles 44.

The drive shaft 46 may be made of the same material as the rotor poles 44 or may be made of a different material. The drive shaft 46 may have axially outer portions 46b, which may support bearing arrangements 50. The axially outer drive shaft portions 46b may have a different radial profile from the central portion 46a so as to fit with commercially available bearing arrangements.

Bearing arrangements 50 may mechanically couple the stator assembly comprising outer carrier 20 to the rotor assembly comprising inner carrier 40 such that the rotor assembly may rotate relative to the stator assembly.

The drive shaft 46 may be hollow, such that there may be a cylindrical cavity formed through the rotor arrangement 10. The cylindrical cavity may be used to house ancillary components, such as brakes and encoders, and may be used to conduct heat away from the rotor assembly 40.

In the example shown, each of the bearing assemblies 50 has an inner race 54 arranged to engage with the axially outer portions of the drive shaft 46b and an outer race 52 arranged to couple to the stator assembly 20, and in particular the end shields 24 of the stator assembly 20. This coupling may be direct or indirect as set out later in this specification. Between the inner and outer bearing races 52, 54, there is a plurality of rolling elements 56, which can be provided in the form of rollers or the illustrated ball bearings.

A support 58 for the bearing, which may be termed a bearing cartridge may be situated between each outer race 52 and the stator assembly 20. The bearing cartridge 58 may provide the function of a radial and/or axial spacer, which may allow the bearing arrangement 50 to be a commercially available bearing arrangement, without prescribing specific dimensions to the stator assembly 20. The bearing cartridge 58 may thereby allow a greater design flexibility. The bearing cartridges 58 may therefore each be an annular part or may be a formed of a plurality of arcuate parts.

In some examples, the motor assembly 10 may have an end housing 15, which may be a simple covering on an axial end of the motor in order to shield internal moving parts. The end housing 15 may also inhibit ingress of dirt, fluids, dust or other contaminants.

Within the drive shaft 46, there may be other ancillary features, also referred to as auxiliary modules, of the electric machine assembly 10. For example, a brake 70 and brake armature 72 may be coupled to the rotor and stator assemblies and an encoder 82 may also be coupled to the rotor and stator assemblies. It will be understood that a range of different such ancillary components may be provided within the internal cavity, and that the internal cavity may therefore provide a greater range of design freedom to the motor arrangement 10, providing a range of functionalities of the motor arrangement 10 with a substantially similar external shape and size.

For coupling the rotor assembly 40 and stator assembly 20 to the relevant auxiliary modules, shaft extensions may be provided. The rotor connection plate 14, which may also be referred to as a shaft extension 14, may be arranged to couple the drive shaft 26 to external components, and may also comprise an interior shaft extension 71. The interior shaft extension 71 may pass axially through the motor and may couple to the brake armature 72 and to the encoder 82. A stationary interior shaft extension 80 may also be provided for coupling the stator assembly 20 to the encoder 82 and to the brake 70. The stationary interior shaft extension 80 may provide a stationary reference radially within the drive shaft 46. A temperature sensor 75 may be provided on the stationary interior shaft extension for measuring the internal temperature of the machine 10.

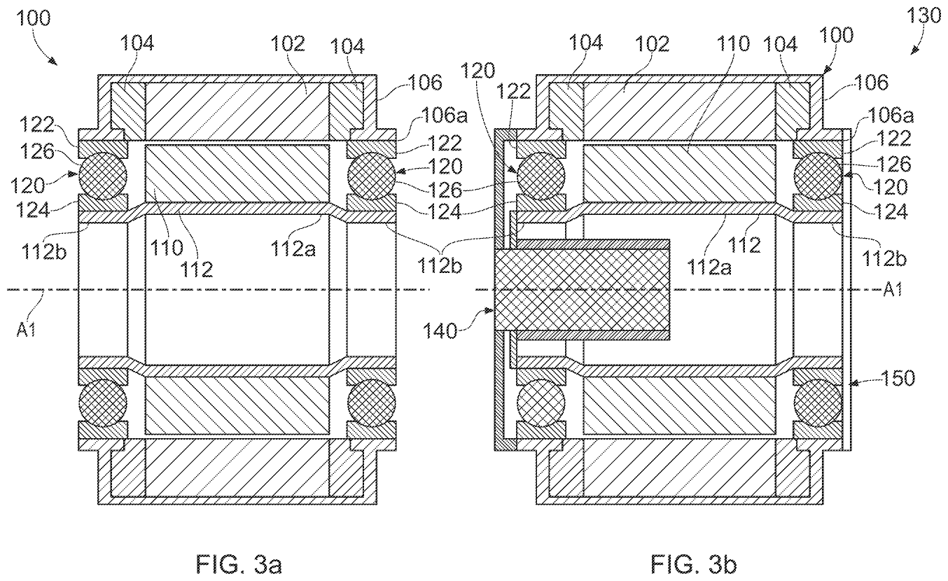

FIG. 3a shows an electric machine module 100, which may form a portion of an electric machine assembly or electric motor assembly. The module 100 comprises a stator 102, a rotor 110, a stator frame 106, a rotor shaft 112 and a bearing assembly 120 comprising an inner race 124, outer race 122 and rolling elements 126 between the two races. The module 100 may also be considered an electric machine of itself since it comprises the main components of an electric machine.

The stator 102 may comprise stator posts, electrical windings, a back-iron for supporting the stator posts and various other components, including any components of the arrangements described above in relation to FIGS. 1 and 2. Portions of potting compound 104, which may include and surround portions of windings extending through the stator 102, are arranged at at least one, or both, axial ends of the stator 102 and are surrounded by the stator frame 106. The stator frame 106 includes end shields on both axial ends, and the end shields are integrated with an annular frame portion extending around the stator. As is the case for the end shields 24 described with reference to FIG. 2, the stator frame 106 covers the axial ends of the potting compound 104 at axial ends opposite the stator 102 and also curves around the potting compound 104 to as to provide a support surface 106a for coupling to the bearing arrangement 120. The stator frame 106 also covers a radially outer surface of the potting compound 104 in order to protect the potting compound 104. By providing the support surface 106a, the stator frame 106, comprising its end shield, can have multiple functions in that it provides a surface for coupling to a bearing assembly as well as protecting the potting compound 104 and strengthening the stator assembly.

The rotor 110 may be substantially similar to the above-described rotor and inner carrier assembly described in relation to earlier figures and may comprise rotor poles and permanent magnets, the rotor poles being ferromagnetic. The rotor 110 may be fixed to a rotor shaft 112, which may also be referred to as a drive shaft 112, and which may be hollow, such that there is an interior cavity that may contain ancillary features or through which wires may pass.

The drive shaft 112 may have a first portion 112a for supporting and/or coupling to the stator 110 and second portions 112b, which may be axially outer portions 112b for supporting the bearing arrangements 120. The bearing arrangements 120 may be substantially similar (i.e. the two separate bearings at opposite axial ends of the electric machine 100 may be substantially similar). This may reduce the number of different parts required for the motor and may thereby simplify assembly thereof.

FIG. 3b shows an electric machine assembly 200 incorporating the electric machine module 100 shown in FIG. 3a, and further auxiliary modules. The electric machine assembly 200 further comprises a brake assembly 140 and an encoder assembly 150. The brake assembly 140 and encoder assembly 150 may each be coupled to both of the stator and rotor assemblies, to provide a braking torque and to measure the position and/or speed of the rotor respectively. The encoder 150 acts to detect a relative rotational position of the inner and outer carriers or rotor and stator assemblies, as the case may be. The encoder can provide output signals representing such movement, or relative rotational positions.

The encoder 150 and brake assembly 140 may be attached at either axial end of the electric machine module 100 as the mechanical connectors of the electric machine module 100 may be substantially similar on both axial ends and/or may be symmetrical about a plane perpendicular to the axis of rotation A1. The encoder 150 and brake assembly 140 may be arranged within the outer radius of the electric machine module 100, and in some cases at least a portion of the auxiliary modules may be situated within the cylindrical cavity inside the drive shaft 112.

The electric machine assembly 200 and the electric machine module 100 may therefore be electric machines with substantially similar rotors, stators, and bearing assemblies and may differ only in what auxiliary modules are present. The electric machine assembly 200 and electric machine module 100 may also have the same outer shape and overall size and may have the same electrical and mechanical connectors for connecting to a power source or an external driver.

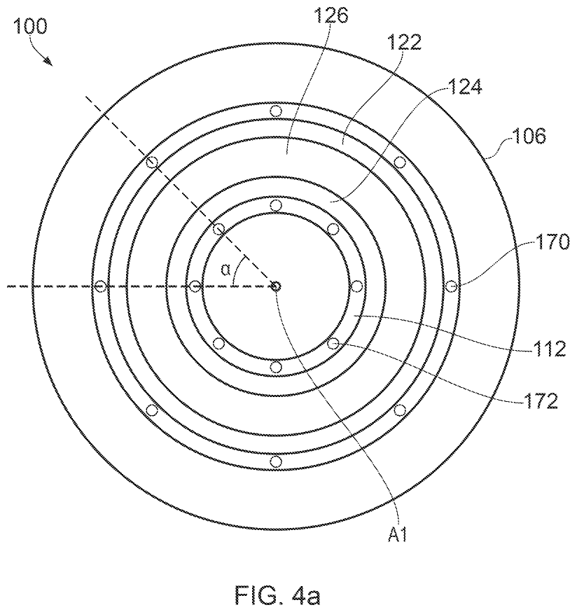

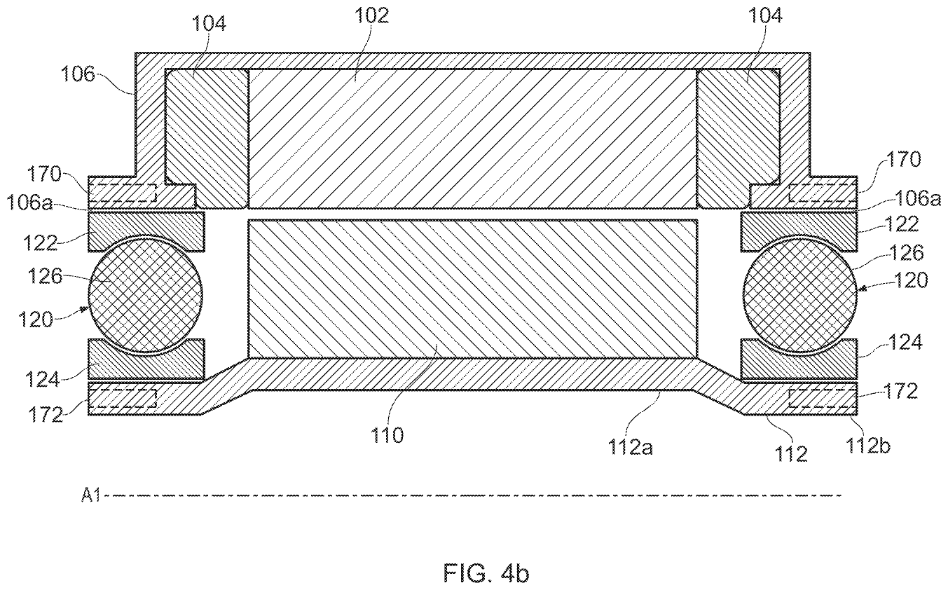

FIG. 4a shows an end view of the electric machine module 100 of FIG. 3a, with the mechanical connectors 170, 172 shown. It will be understood that the two axial ends of the electric machine module 100 may be substantially similar and so FIG. 4a may be considered as showing either axial end. In FIG. 4a, it can be seen that connectors 170, which may be formed as cavities, blind holes, tapped holes, or may be protrusions, may be formed in an equiangular, rotationally symmetric arrangement on an end surface of the stator frame 106, which may also be an end surface of the stator arrangement. The connectors 170 may be separated by an angle α, which in the present case, where there are 8 connectors 170, may be 45°, but the angle α and/or the number of connectors may vary. Generally, the connectors 170 may be on an axial end of the stator arrangement and may have a rotationally symmetric arrangement.

Rotor connectors 172, which, similarly to the connectors 170, may be cavities, blind holes, tapped or threaded holes or may be protrusions, are found on an end surface of the rotor shaft 112 and may have an equiangular, rotationally symmetric arrangement. While the number of connectors 172 on the rotor assembly may be the same as the number of connectors 170 on the stator assembly, this is not essential and the two numbers of connectors 170, 172 may be different. The connectors 172 on the rotor assembly may also be separated by an angle α, which may be the same as the angle α separating the connectors 170 of the stator arrangement, or may be different.

FIG. 4b shows how the connectors 170, 172 may be formed as holes within the end shields, or may equally be considered as holes within an end plate 106a of the stator frame 106. The connectors 172 of the rotor assembly may be formed within an axial end surface of the rotor shaft 112a, and so may be within an axially outer portion 112b of the rotor shaft 112.

In FIGS. 4a and 4b, it may also be seen that the bearing cartridge may be omitted and that a curved, radially inner surface of the stator frame 106 (or, equivalently, of the end shields) may couple to the outer race 112 of the bearing assembly 120 directly. This may provide a reduced part count for the electric machine.

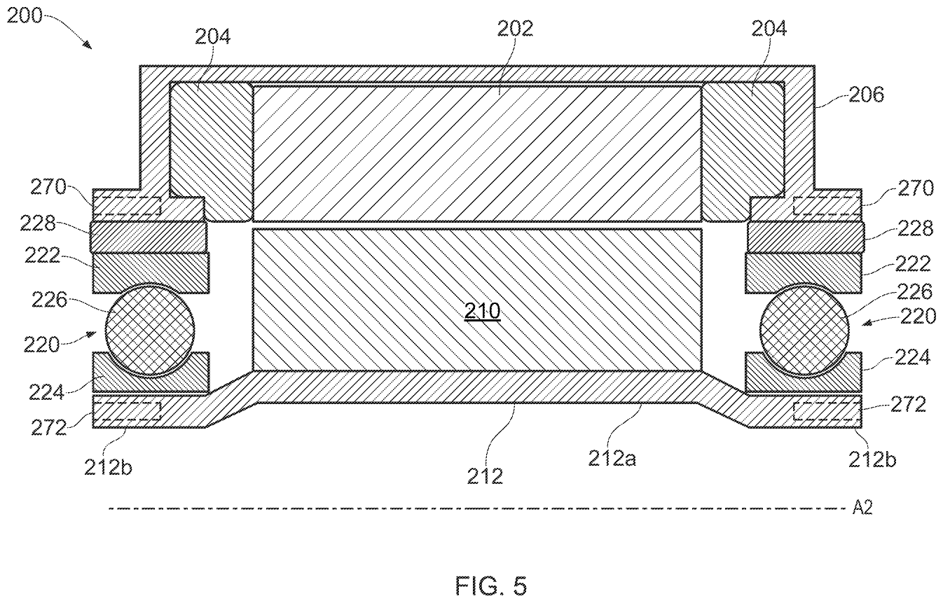

FIG. 5 shows an alternative electric machine module 200 in a radial cross section. Since the electric machine module 200 may have multiple parts which are substantially similar to the equivalent parts shown in FIGS. 3a and 4b, the description of the parts is not repeated here in the interests of efficiency of the disclosure.

FIG. 5 shows how a bearing cartridge 228 may be used in order to allow a smaller bearing arrangement 220 to be used, which may also be a commercially available bearing arrangement 220, since only the size of the bearing cartridge 228 needs to be varied in order to allow any size bearing arrangement 220 to be employed. The bearing arrangement 220 may therefore have an inner race 224, outer race 222 and rolling elements 226 between the races, all of which are commercially available products.

Further, by using a bearing cartridge 228, the bearing 220 may be moved further from the stator 202. Since both of the stator 202 and bearing arrangement 220 may generate significant heat during use, separating the two parts, such as by arranging the bearing arrangement 220 to be radially inward of the stator 202, may reduce the build-up of heat within the electric machine module 200. This may also be facilitated by the difference in radius of the radially outer surfaces of the central and axially end portions 212a, 212b of the rotor shaft 212. There may be provided a first bearing 220 at a first axial end of the inner and outer carriers, i.e. rotor 210 and stator 202, and a second bearing 220 at a second axial end of the inner and outer carriers, i.e. rotor 210 and stator 202.

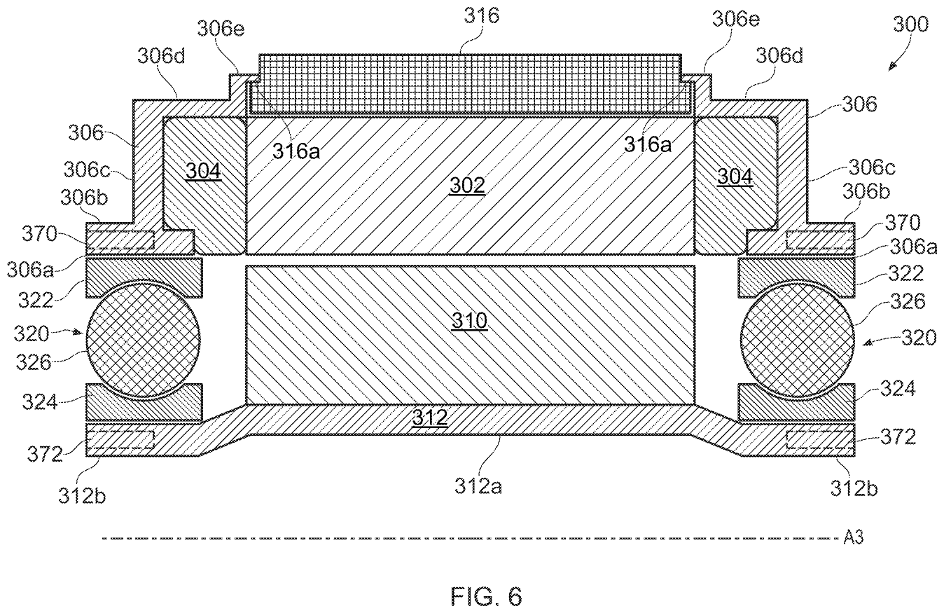

FIG. 6 shows a further alternative electric machine module 300, which is substantially similar to the electric machine module shown in FIG. 2. In the electric machine module 300, the stator frame is separated into stator end shields 306 and a central stator frame portion 316.

The stator end shields 306 each have a radially inner curved surface 306a, which may be an arcuate surface in the case that the end shields 306 do not extend about a full 360°, such as being semi-annular end shields 306. Alternatively, the curved surfaces 306a may be cylindrical curved surfaces 306a where the end shields 306 are complete annuli. The radially inner curved surfaces 306a may be formed on inner end shield plates 306b, which may also comprise mechanical connectors 370 formed on the end plates 306b as holes, which optionally may be threaded or tapped. Alternatively, as explained above, the connectors 370 may be formed as protrusions.

The plates 306b may extend axially inwardly and axially outwardly from the end shield 306, the axially inwardly extending portion at least partially covering an inner surface of the potting compound 304 and the axially outwardly extending portion having the connector 370.

A radially extending portion 306c of the end shield 306 may extend over an axially outer surface of the potting compound 304 so as to protect the potting compound 304 from external forces at an axial end of the potting compound 304. The radially extending portion 306c may have a radial dimension substantially similar to that of the potting compound 304, such that the entire axial end of the potting compound 304 may be covered by the end shield 306.

The end shield 306 may also have an outer, axially extending portion 306d extending over a radially outer surface of the potting compound 304. This may protect the potting compound 304 from external forces from radially outside the electric machine module 300. The outer, axially extending portion 306d may also act to couple the end shield to an axially central portion 316 of a stator frame, as explained below.

The end shields 306 may also comprise a portion 306e having an L-shaped cross-section and being arranged to engage with and to overlap a coupling portion 316a of the stator frame central portion 316. The stator frame coupling portion 316a may be a protrusion from the stator frame 316 extending axially and may have a shape arranged to engage with the corresponding portion 306e of the end shield 306.

By forming the stator frame of separate end shields 306 and a central portion 316, the stator frame may be applied separately, allowing the stator frame to be constructed and assembled over the formed stator 302 and potting compound 304. The end shields 306 may therefore be slid onto the rest of the electric machine module 300 in an axial direction, after the potting compound 304 has been set. This may simplify manufacture. The end shields 306 may also be formed of a different material from the stator frame central portion 316.

The stator end shields 306 may be formed of the same material as the bearing arrangement 320, or a material which is different and has a substantially similar coefficient of thermal expansion. By providing an end shield 306 and bearing arrangement 320 having a substantially similar coefficient of thermal expansion, which may be within a tolerance of 50%, impingement of components upon each other or the generation of internal stresses when components heat up during use may be avoided. The bearing arrangement comprises an inner race 324, an outer race 322 and rolling elements 326, which may all be formed of the same material, or of materials having substantially similar thermal expansion coefficients.

Further, the axially outer portions 312b of the rotor shaft 312 may be formed of the same material as the bearing arrangement 320 and/or the end shield 306 or may be formed of a different material having a substantially similar thermal expansion coefficient. In the case that all three of the axially outer portion 312b of the rotor shaft, the bearing arrangement 320 and the end shield 306 have the same or substantially similar thermal expansion coefficient, the motor components may all move radially outwardly by the same amount when thermally heated and so component clash and thermal stresses may be reduced. This may also allow the operational air gap between the rotor 310 and the stator 302 to be reduced, as tolerances within the electric machine module 300 may be improved, allowing for a smaller airgap to be used without increasing the risk of clashes between the inner and outer carriers. To this end, the rotor shaft 312 may be formed of multiple materials. For example, the central portion 312a may be formed of a different material from the axially outer portions 312b.

The end shield 306, bearings 320 and rotor shaft 312 may all be formed of steel, and may be formed of different types of steel. The steels forming the end shields 306, bearings 320 and rotor shaft 312 may also have the same thermal expansion coefficient as the rotor 310 and stator 302, or may be within at least 50%. Alternatively, the end shield, bearings and rotor shaft may all be formed of aluminium.

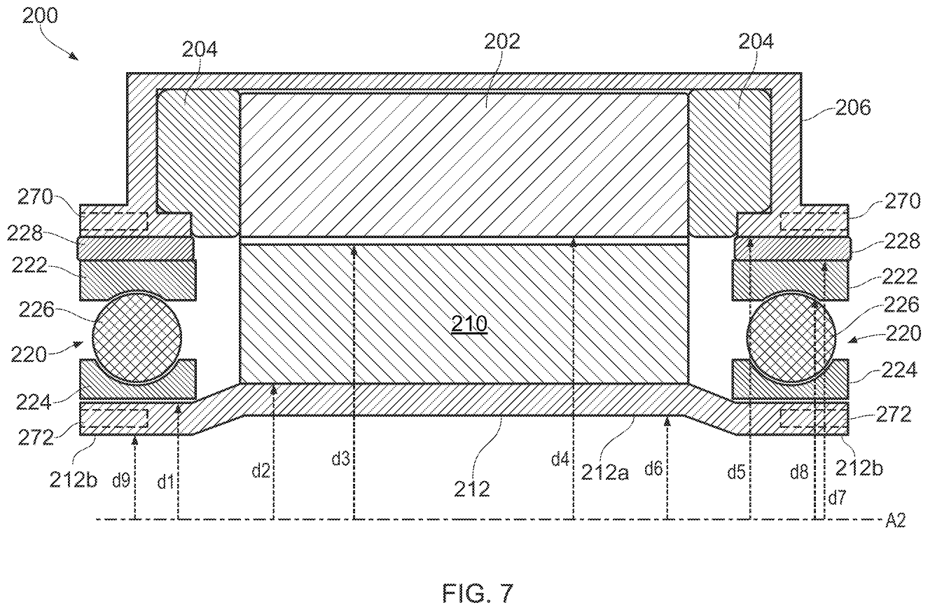

FIG. 7 shows the electric machine module 200 from FIG. 5, with relevant radial dimensions marked up. The dimensions are shown in table 1 below:

TABLE 1

| Dimension | Description |
|---|---|
| D1 | Radial dimension of outer surface of |
| | axially outer portion 212b of rotor shaft |
| | 212 |
| D2 | Radial dimension of inner surface of |
| | inner carrier |
| D3 | Radial dimension of outer surface of |
| | inner carrier, i.e. rotor 210 |
| D4 | Radial dimension of inner surface of |
| | outer carrier, i.e. stator 202 |
| D5 | Radial dimension of inner surface of |
| | outer carrier support, i.e. stator frame 206 |
| D6 | Radial dimension of inner surface of |
| | central portion of rotor shaft 212a |
| D7 | Radial dimension of outer surface of |
| | bearing 220 |
| D8 | Radial dimension of outer bearing |
| | surface |
| D9 | Radial dimension of inner surface of |
| | inner carrier shaft, i.e. drive shaft axially |
| | outer portion 212b |

As noted above in relation to FIG. 5, there may be provided a first bearing 220 and a second bearing 220, which may be provided at respective axial ends of the inner and outer carriers 210, 202. References herein to the bearing 220 may apply to one, or both, of the bearings 220. While a bearing 220 provided at each axial end of the inner and outer carriers 202, 210 is advantageous, as a skilled person will appreciate, there may be provided more than two bearings 220 arranged in any appropriate arrangement. Where a plurality of bearings are used, two or more, or all, may be identical in terms of one or more of size, shape, material, orientation and radial location.

With reference to FIG. 7, the inner carrier, which may be the rotor 210, may have an inner surface. The inner surface may have a radial dimension D2. The bearing 220 may have an outer bearing surface, having a radial dimension D8.

The outer bearing surface may be an outer surface of an outer race of the bearing 220, or an inner surface of an outer race of the bearing 220. The outer bearing surface may have a dimension D8 that is at least as large as the inner dimension of the inner carrier D2. The dimension D8 of the outer bearing surface may be measured at an outermost point of the outer surface, or an outermost point of the inner surface. An inner bearing surface, which may be a bearing surface (i.e. outer surface) of an inner race of the bearing, or an inner surface of an inner race of the bearing, may be proximate an inner surface of the inner carrier 210.

The outer bearing surface may be aligned with or radially proximate to an inner surface of the outer carrier, which may be the stator 202. The outer surface of an outer race of the bearing may be aligned with or radially proximate to an inner surface of the outer carrier, which may be the stator 202.

There may be provided a first bearing 220 provided at a first axial end of the rotor and stator 202, 210, and a second bearing 220 provided at a first axial end of the rotor and stator 202, 210. The first end may be opposite to the second end. The bearing 220 may be disposed radially proximate to both the inner and outer carriers 210, 202. The bearing 220 may be disposed axially proximate to both the inner and outer carriers 210, 202. The bearing 220 may be disposed substantially axially outwardly of the inner carrier 210.

The outer carrier 202 may extend axially to a greater extent than the inner carrier 210. The bearing 220 may be disposed substantially in a corner defined between the outer carrier 202 and the inner carrier 210.

The outer carrier 202 may have a length in an axial direction from a first end to a second end. The bearing 220 may be disposed wholly within the outer carrier 202 at an axial position between the first end and the second end. The housing may comprise at least one end cover 206. The end cover 206, outer carrier 202, and inner carrier 210 may define an opening in which the bearing 220 is disposed. A potting compound 204, the end cover 206, outer carrier 202, and inner carrier 210 may define an opening in which the bearing 220 is disposed.

The inner carrier 210 may comprise an inner carrier shaft 212 which may extend substantially axially from the inner carrier 210, and the bearing 220 may be disposed between the inner carrier shaft 212 and the outer carrier 202, or between the inner carrier shaft 212 and the end cover 206. The bearing 220 may be disposed between an axially outer portion 212b of the rotor shaft 212 and the outer carrier 202, or between the axially outer portion 212b and the end cover 206.

The end cover 206, outer carrier 202, inner carrier 210 and inner carrier shaft 212 may define an opening in which the bearing 220 is disposed. Alternatively, the end cover 206, inner carrier 210 and inner carrier shaft 212 alone may define an opening in which the bearing 220 is disposed.

The outer carrier 202 may have an axial length of at least 40 mm, optionally at least 45 mm, optionally at least 47 mm, optionally at most 47 mm. Other axial lengths of the outer carrier are within the scope of this disclosure and can be implemented without substantially affecting the inventive concept described herein. The diameter of the inner surface of the outer carrier 202 (2×D4) may be at least 7 cm, optionally at least 9 cm, optionally at least 10 cm, optionally at least 13 cm, optionally at least 13.3 cm. The diameter of the outer surface of the outer carrier 202 may be at least 10 cm, optionally at least 12 cm, optionally at least 15 cm, optionally at least 15.5 cm, optionally at least 15.9 cm. The ratio of the inner diameter of the outer carrier 202 to the outer diameter of the outer carrier 202 may be at least 0.6, optionally at least 0.7, optionally at least 0.75, optionally at least 0.8.

The inner carrier 210 may have an axial length of at least 40 mm, optionally at least 45 mm, optionally at most 45 mm. Other axial lengths of the inner carrier are within the scope of this disclosure and can be implemented without substantially affecting the inventive concept described herein. The inner carrier 210 may be longer in an axial direction than the outer carrier. The inner and outer carriers may have the same nominal length, but a tolerance such that the inner carrier is longer than the outer carrier. Alternatively, the outer carrier may be longer than the inner carrier as this arrangement may provide a more preferable flux path and therefore an improved efficiency. The inner and/or outer carrier may have an axial length in the range 20 mm to 15 cm. The diameter of the inner surface of the inner carrier 210 (2×D2) may be at least 10 cm, optionally at least 10.5 cm. The diameter of the outer surface of the inner carrier 210 may be at least 10 cm, optionally at least 13 cm, optionally at least 13.2 cm. The ratio of the inner diameter of the inner carrier 210 to the outer diameter of the inner carrier 210 may be at least 0.6, optionally at least 0.7, optionally at least 0.75, optionally at least 0.8, optionally at least 0.83.

The rotor 210 may have a back iron thickness of less than or equal to 1.5 mm, preferably less than or equal to 1.4 mm. The stator 202 may have a back iron thickness in the range of 1 mm and 4 mm. Optionally, the stator 202 has a back iron thickness of less than or equal to 3 mm, optionally less than or equal to 2.5 mm.

With reference to FIG. 7, an airgap is provided between the stator 202 and the rotor 210. The airgap may be defined between an outer surface of the rotor 210 and an inner surface of the stator 202. The airgap may have a radial dimension of: the radial dimension of the inner surface of the stator 202, D3, minus the radial dimension of the outer surface of the rotor 202, D4, i.e. the airgap dimension=D3−D4. The airgap may have a radial dimension of at least 0.25 mm. The airgap may have a minimum radial dimension of 0.25 mm, optionally at least 0.3 mm, optionally at least 0.31 mm. The airgap may have a maximum radial dimension of 0.4 mm, optionally 0.41 mm, optionally 0.5 mm.

The ratio of the diameter of the outer bearing surface to the airgap radial dimension may be at least 250, optionally at least 500. The ratio of the diameter of the inner surface of the outer carrier 202 to the airgap radial dimension may be at least 250, optionally at least 530.

With reference to FIG. 7, D2 may be larger than D1. D6 may be larger than D9. D1 and D2 may each be larger than D6. D4 is larger than D3. D5 may be larger than D7, which may be larger than D8. Where no bearing cartridge 228 is provided, D5 may be equal to D7. The rotor shaft 212 may have a substantially uniform thickness in a radial direction, i.e. D1 minus D9 may be equal to D2 minus D6.

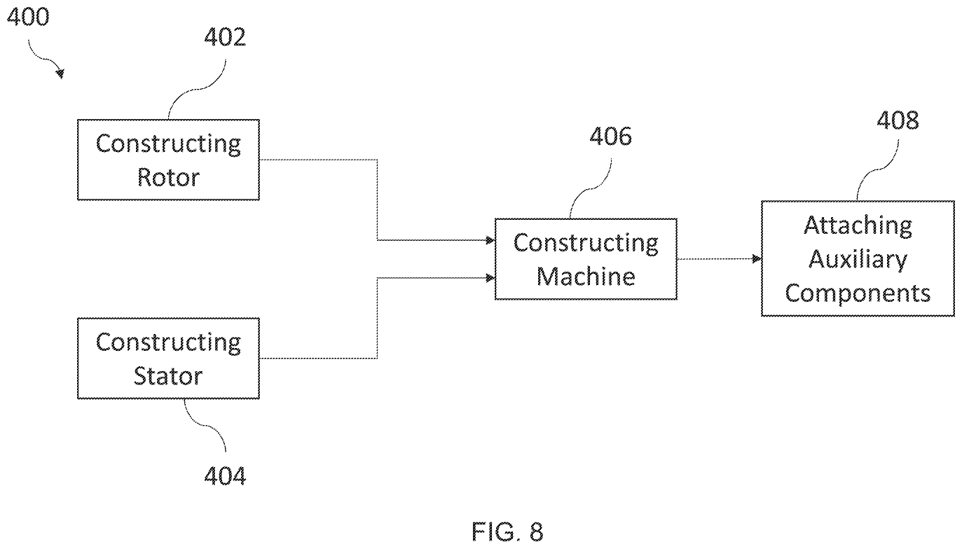

FIG. 8 is a flowchart illustrating a method 400 of constructing an electric machine as disclosed above.

At step 402, the rotor assembly is constructed. The rotor assembly may be an inner component, or carrier. This may involve forming the rotor poles from a ferromagnetic material, such as a soft iron laminate. The rotor poles may have permanent magnets attached to them in an alternating fashion to form the rotor. The rotor may then be fixed to a rotor shaft to form the rotor assembly.

At step 404, the stator assembly is constructed. The stator assembly may be an outer component, or carrier. As shown in FIG. 4, this may be performed separately from the rotor construction. The stator may be constructed by providing stator posts formed of a soft magnetic material and winding wire around the posts, or by placing wound wire over the stator posts. The windings or portions thereof may be put in a potting compound, which may be injected into the stator. The potting compound may be injected before or after a stator frame or end shields are applied to the stator assembly.

The rotor or stator assemblies are both subassemblies of an electric machine.

At step 406, the stator assembly and rotor assembly are combined to form the electric machine. At this stage bearing arrangements may be added, as may external frames and electrical connectors.

Auxiliary modules, such as brakes and encoders, may be added at step 408.

While previous motors may require encoders and brakes to be added during stator and rotor construction, auxiliary modules may be added late in the construction of the machine described herein due to the abundance of connectors and the available space inside the rotor.

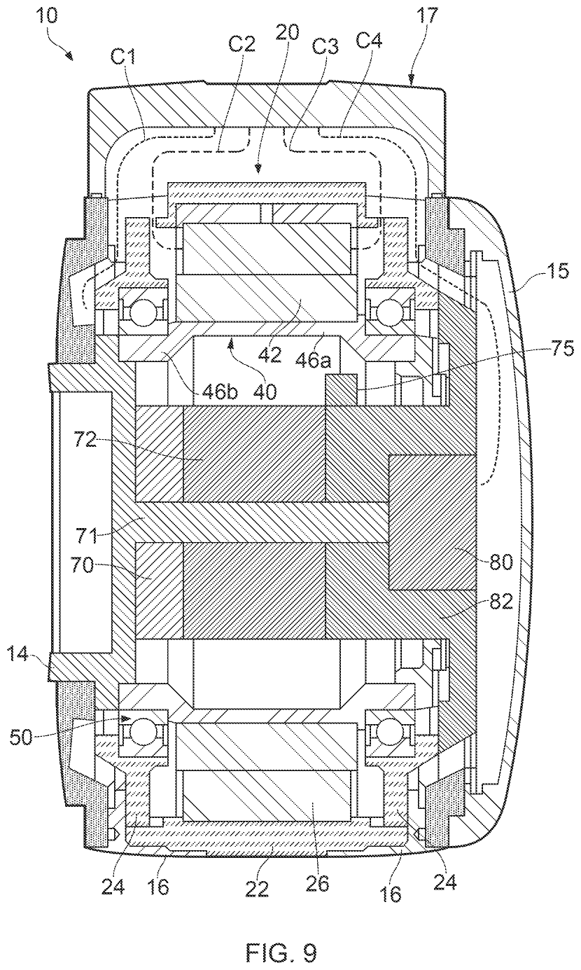

FIG. 9 shows a cross section of the electric machine 10 of FIG. 1 taken along plane B-B-B-B. In FIG. 9, pathways for the conveyance of wires within the electric machine 10 are marked. The Electric machine has a connector block 17 for carrying the electrical connectors 18, and the connector block 17 has a fairing or cowling extending away from the generally cylindrical motor housing 16, 22. The connector block 17 may be axially aligned with at least a part of the stator 26 and rotor 42, and may be arranged in an axial centre of the machine 10. However, in particular where the machine 10 has a greater axial length, the connector block 17 may extend over only a portion of the stator 26 and rotor 42 and may not necessarily be aligned in an axially central position with respect to the stator and rotor. However, in general, the connector block will be aligned such that the connectors are located between first and second ends of the motor, and may be aligned such that the connectors are aligned between first and second axial ends of the stator, or outer carrier.

In order to provide power and/or data to and/or from the stator 26 and auxiliary modules such as the brake 72 and encoder 80, there may be cables or wires provided inside the electric machine 10. Such cables or wires may follow one or more of pathways P1 to P4 running between the connectors 18 and the stator 26, brake 72 or encoder 80. The cables or wires, and the pathways which they follow, may run within channels C1 to C4 provided in a housing assembly of the motor.

A stator channel C2 may be provided for conveying wires between the stator 26 and the connector 18. The stator channel C2 extends through the end shields 24 and outer housing section 22, referred to collectively as a stator or outer carrier housing, at an axially outer location, such that an axial end of the stator 26, which may be considered as the first axial end of the stator, may be connected to a connector 18 which is axially located closer to the axial centre of the stator 26 than the first axial end of the stator 26 is. A cable or wire may therefore follow pathway P2 to carry power from a connector 18 to the outer carrier and in doing so may pass via the stator channel C2 provided in the housing assembly of the motor.

A second stator channel C3 may also be provided at an opposite end of the motor to the first stator channel C2. The second stator channel C3 may be substantially symmetrical to the first stator channel C2. The second stator channel C3 may be substantially similar to the stator channel C2 and may provide a similar function, except that the stator channel C3 may extend through the axially opposite end shield 24, or through the central housing portion 22, at an axially opposite end and may allow a pathway P3 to pass to the axially opposite end of the stator 26, which may be considered as the second axial end of the stator, to permit the connection of cables or wires to the stator 26 at the second axial end.

The stator channels C2, C3 may be used to provide power to the stator 26 from the connectors 18. Alternatively, where the electric machine 10 is a generator, cables running along the pathways P2, P3 via the stator channels C2, C3 may transfer power from the stator 26 to the connector 18. By providing two pathways P2, P3 and two channels C2, C3 arranged symmetrically, power may be provided to, or taken from, the windings of the stator 26 at either axial end, allowing the same design of motor to be configured to be placed in applications where mirrored motors are required.

The electric machine 10 may also have an auxiliary module channel C1, which may extend past the first axial end of the stator 26 and rotor 42 axially outside the stator and rotor and a pathway P1 may provide communication between the electrical connectors 18 and an auxiliary module radially inside the rotor 42, such as a brake 72 or an encoder 80 via the auxiliary module channel C1. The pathway P1 may be covered by an end cover or end housing 15. This may protect internal wires from damage.

While there may be only a single pathway P1 providing communication to the auxiliary modules, the electric machine 10 may be designed such that an equivalent pathway may be provided at either axial end of the machine 10. Therefore, a second auxiliary module channel C4 may be provided. The second auxiliary module channel C4 may extend past the stator 26 and rotor 42 at the opposite axial end from the auxiliary module channel C1. While a pathway P4 passing through the second auxiliary module channel C4 of the machine 10 shown in FIG. 9 is closed off by a shaft extension 14 coupled to the rotor 42, it will be understood that a pathway may be provided at axial either end, opposite to an axial end at which a shaft extension is coupled, such that a pathway may be provided at either axial end of the electric machine 10 for providing wired communication between the connector 18 and an auxiliary module radially inside the rotor 42.

As a result, an auxiliary module may be provided within the rotor assembly 40 and the shaft extension 14 may be provided at either axial end, with the auxiliary module communicating with the electrical connector 18 via a channel at an opposite axial end. Consequently, electric machines having the same design may be arranged in mirrored configurations, allowing the same electric machine to be usable in a greater range of applications.

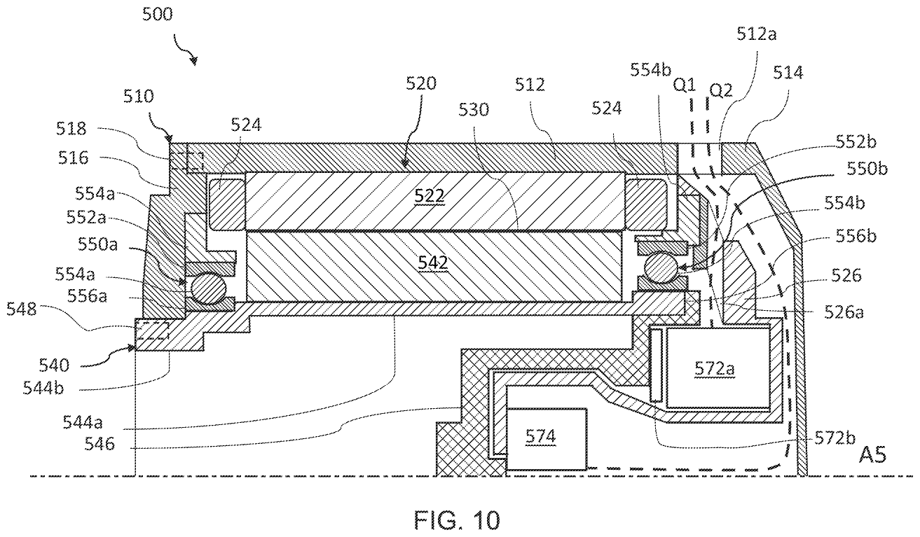

FIG. 10 shows a further electric machine 500, which has an outer carrier assembly 520 comprising an outer carrier 522. The outer carrier may be a stator as in the illustrated embodiment. However, arrangements can be envisaged in which the outer carrier is a rotor and the inner carrier can be considered a stator. In either case, the respective electro-magnetic arrangements can be put in place to create relative rotation between inner and outer carriers, one being considered a stator and the other a rotor. For the purposes of illustration of the examples herein, the outer carrier 522 is referred to as a stator comprised in a stator assembly 520, and the inner carrier 542 a rotor comprised in a rotor assembly 540. The stator 522 comprises a magnetic core, which can comprise a plurality of stator posts and electric windings. The windings may have ends which project from the body of the magnetic stator core 522, and these may be supported in a potting compound 524. The stator 522 is arranged to generate a magnetic field which interacts with a rotor 542. The rotor may comprise permanent magnetic elements and a magnetically conductive core for supporting the permanent magnets and conducting the magnetic flux therefrom. The rotor 542 and stator 522 are separated by an airgap 530. The rotor 542 is comprised in a rotor assembly 540, which comprises the rotor 542 and a rotor shaft 544a, 544b.

The rotor and stator assemblies 520, 540, are coupled via bearing assemblies 550a, 550b. Since the two bearing assemblies 550a, 550b comprise substantially similar parts, only the first bearing assembly 550a is described here, though corresponding features can be seen in bearing assembly 550b, referenced with corresponding ‘b’ suffixes. The first bearing assembly 550a has an inner race 556a and an outer race 552a. The inner and outer races 552a, 556a are separated by rolling elements 554a, which may be evenly spaced around the circumference of the bearing assembly 550a. The second bearing assembly also has inner and outer race 556b, 552b and rolling elements 554b, arranged in a corresponding manner.

Two bearing cartridges 554a, 554b abut the outer races 552a, 552b and couple the outer race 552a, 552b to the stator assembly 520. The bearing cartridges 554a, 554b may be of different sizes and the use of bearing cartridges may allow bearings of commercially available sizes to be used, with the bearing cartridges providing a radial and/or axial spacing function.

The electric machine 500 may be housed within a housing 510, the housing having a substantially tubular portion 512, a first end portion 516 and a second end portion 514. The housing may be rigidly fixed to the stator 522 and in some cases may be considered as part of the stator assembly 520. By separating the housing 510 into separate portions, electric machines of different axial lengths may be produced, the electric machines having substantially similar end portions 516, 514, and only the tubular portion 512 may need to be altered to accommodate differently sized magnetic arrangements.

Inside the electric machine 500 are provided two auxiliary modules. The auxiliary modules are a brake 572a, 572b arranged to brake the rotor relative to the stator and an encoder 574 arranged to measure the position or speed of the rotor relative to the stator. However, it will be understood that the auxiliary modules may have their positions swapped, or alternative auxiliary modules may be provided, such as a power meter. The auxiliary modules are coupled to the rotor and stator assemblies via respective optional auxiliary members 546, 526. An optional inner auxiliary member 546, which in this case is a rotor auxiliary member, is coupled to the rotor shaft 544a so is to rotate with the rotor shaft 544a. A direct connection to the shaft could however be provided. An advantage of a separate auxiliary member is that it can facilitate insertion and removal of the auxiliary module(s) in a module which is connected to the rotor and stator assemblies more easily or in a more readily accessible location. The coupling between the auxiliary modules and respective assemblies may be a removable or releasable coupling, such as a threaded coupling, which may be in the form of bolts. This means that the rotor auxiliary member 546 may be removed in cases where an auxiliary module is not desired, or for maintenance or replacement, for example. The auxiliary rotor member 546 is therefore coupled at a first end of the shaft 544 and extends therefrom in an axial direction towards the second end of the rotor shaft 544, extending axially inside the rotor shaft 544. By extending axially inside the rotor shaft and having a hollow or cylindrical shape, the rotor auxiliary member 546 provides space inside itself for auxiliary modules, which may be coupled to an outer auxiliary member 526, which in this case is a stator auxiliary member 526, which extends in the same direction.

To this end, the stator auxiliary member 526 is coupled to a first end of the stator assembly 520, which is adjacent the first end of the rotor assembly 540. The stator auxiliary member 526 extends around the rotor assembly 540 and axially inside the rotor assembly 540 and inside the optional rotor auxiliary member 546, towards an opposite axial end of the stator assembly 520. The function of the stator auxiliary member, or outer auxiliary member 526, is to transmit movement and/or force or torque between the outer carrier 522 and the auxiliary module. To do so, the outer auxiliary member may extend radially past an end of the inner carrier 542, to mechanically connect the auxiliary module located radially within the inner carrier, to the outer carrier. Where the auxiliary module is a brake 572, it may comprise a brake armature 572a coupled to the stator auxiliary member 526 and a brake disk 572b coupled to the rotor auxiliary member 546. It will be understood that the brake assembly, or any other auxiliary module may be annular and so the stator auxiliary member 526 may extend axially through the brake assembly 572 or a different auxiliary module. The stator auxiliary member 526 and rotor auxiliary member 546 are then coupled to another auxiliary module, in this case the encoder 574, which is radially inside both of the rotor auxiliary member 546 and stator auxiliary member 526.

In order to allow electronic communication between the auxiliary modules and the exterior of the electric machine 500, pathways Q1 and Q2 are provided for cabling between the auxiliary modules and the exterior of the electric machine 500. A first pathway Q1 is provided from outside the electric machine 500 to the brake 572. A portion of the pathway Q1 passes through a hole 526a within the stator auxiliary module. The second pathway Q2 is arranged generally axially outside the stator auxiliary member 526 and passes axially inside the stator auxiliary member 526 and the rotor auxiliary member 546 proximate to the axis A5 of the electric machine 500.

For connecting the electric machine 500 to external parts, such as robotic members to be rotated, or gearboxes, there are provided external mechanical connectors 518 and 548. The external connectors 518 are for coupling the housing 510 and thereby the stator 522 to an external reference member, and the rotor external connectors 548 are arranged within the rotor shaft 544, and in particular are arranged in a portion of the rotor shaft 544b, which has a smaller inner diameter than a central portion of the rotor shaft 544a.

The external connectors may have the form of threaded holes and may be substantially similar to the above-described connectors with reference to FIGS. 2 to 4.

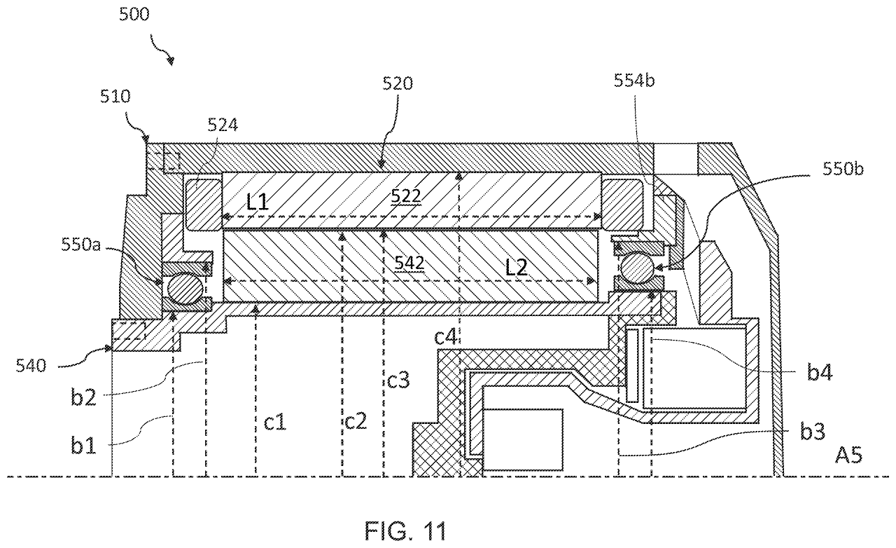

FIG. 11 shows the electric machine 500 with dimensions added. The dimensions are described below in table 2.

TABLE 2

| Dimension | Description |
|---|---|
| B1 | Radius of inner surface of |
| | inner bearing race of |
| | second bearing 550a |
| B2 | Radius of outer surface of |
| | outer bearing race of |
| | second bearing 550a |
| B3 | Radius of outer surface of |
| | outer bearing race of first |
| | bearing 550b |
| B4 | Radius of inner surface of |
| | inner bearing race of first |
| | bearing 550a |
| C1 | Radius of inner surface of |
| | rotor 542 |
| C2 | Radius of outer surface of |
| | rotor 522 |
| C3 | Radius of inner surface of |
| | stator 522 |
| C4 | Radius of outer surface of |
| | stator 522 |
| L1 | Axial length of stator 522 |
| L2 | Axial length of rotor 522 |

The dimensions of the electric machine 500 may be substantially similar to those discussed above with reference to FIG. 7. In particular, the ratios described with reference to FIG. 7 may apply to the electric machine 500 of FIG. 11.

With reference to the axial lengths of the rotor and stator L1, L2, it should be understood that the electric machine designs are intended to encompass any lengths L1, L2, as the axial extent of the electric machine may be varied without substantially altering the fundamental design of the electric machine 500. However, providing a stator length L1 greater than the rotor length L2 may improve the efficiency of the electric machine 500.

Further, the inner diameter of the first bearing B4 may be greater than the inner diameter of the second bearing B1, and in particular may be greater by at least 10%. This may allow more internal space for an auxiliary module to be provided. Further, in order to allow the first and second bearings to have similar thicknesses, the outer diameter of the first bearing B3 may be greater than the outer diameter of the second bearing B4, and in particular may be greater by at least 10%.

While the above-described electric machines are electric motors, it will be understood that electric generators may be manufactured having substantially similar constructions and properties. Electric motors may even act as generators when a torque is applied to the rotor by an external force.

Further, the machines described have fixed stators with electrically powered coils driving rotors surrounded by the stator. This is a common configuration, with the power being applied to the stator in a “brushless” motor. However, elements of the disclosure may equally be applied to alternative arrangements. For example, an “outrunner” machine may have the rotor radially outside the stator. In this case, the stator may still comprise end shields, but with the arrangement inverted as the air gap may be radially outside the stator and so the stator may be exposed on a radially outer surface.

Further, power may be applied to, or taken from in the case of a generator, the rotor of an electric machine. In such cases, the rotor may have windings, a potting compound and/or end shields. The rotor may have a construction substantially similar to the stators described above, with the addition of a brushed connection.

1. A radial flux electric machine comprising:
a housing;
an inner carrier having an inner surface; and
an outer carrier spaced apart from the inner carrier by an airgap;
wherein the inner carrier is a first one of: a stator fixedly attached to the housing, and a rotor configured to rotate relative to the stator about an axis, and the outer carrier is the other one of: the stator fixedly attached to the housing, and the rotor configured to rotate relative to the stator about an axis;
a plurality of electromagnetic elements defining magnetic poles, disposed on the rotor or stator so as to generate a radial flux between the rotor and stator as the rotor rotates;
at least one bearing having an outer bearing surface; and
an auxiliary module located within a diameter of the inner carrier, the auxiliary module comprising one or more of: a brake configured to brake the motor and/or a sensor configured to sense at least one operational parameter of the motor;
wherein the outer bearing surface has a diameter that is at least as large as the inner diameter of the inner carrier.

2. The electric machine of claim 1, wherein the outer bearing surface is aligned with or radially proximate to an inner surface of the outer carrier.

3. The electric machine of claim 1, wherein the bearing is disposed radially proximate to both the inner and outer carriers.

4. The electric machine of claim 1, wherein the bearing is disposed axially proximate to both the inner and outer carriers.

5. The electric machine of claim 1, wherein the bearing is disposed substantially axially outwardly of the inner carrier.

6. The electric machine of claim 1, wherein the outer carrier extends axially to a greater extent than the inner carrier.

7. The electric machine of claim 1, wherein the bearing is disposed substantially in an annular region defined by the outer carrier and the inner carrier.

8. The electric machine of claim 1, wherein the outer carrier assembly has a length in an axial direction from a first end to a second end, and the bearing is disposed wholly within the outer carrier at an axial position between the first end and the second end.

9. The electric machine of claim 1, wherein the housing comprises at least one end cover, and the end cover, outer carrier assembly, and inner carrier define an annular opening in which the bearing is disposed.

10. The electric machine of claim 1, wherein the inner carrier comprises an inner carrier shaft which extends substantially axially from the inner carrier, and the bearing is disposed between the inner carrier shaft and the outer carrier.

11. (canceled)

12. (canceled)

13. (canceled)

14. The electric machine of claim 1, wherein the diameter of the inner surface of the outer carrier is at least 7 cm, optionally at least 9 cm, optionally at least 10 cm, optionally at least 13 cm, optionally at least 13.3 cm.

15. The electric machine of claim 1, wherein the diameter of the inner surface of the inner carrier is at least 4.5 cm, optionally at least 6.5 cm, optionally at least 7.5 cm, optionally at least 10.5 cm, optionally at least 10.8 cm.

16. The electric machine of claim 1, wherein the ratio of the diameter of the outer bearing surface to the airgap radial dimension is at least 250:1, optionally at least 500:1.

17. The electric machine of claim 1, wherein the ratio of the diameter of the inner surface of the outer carrier to the airgap radial dimension is at least 250, optionally at least 530.

18. The electric machine of claim 1, wherein the airgap has a radial dimension of at least 0.25 mm.

19. The electric machine of claim 1, wherein the bearing comprises a first bearing at a first axial end of the inner and outer carriers, and a second bearing at a second axial end of the inner and outer carriers.

20. (canceled)

21. (canceled)

22. (canceled)

23. (canceled)

24. (canceled)

25. The electric machine of claim 1, wherein the inner carrier is a rotor configured to rotate relative to the stator about an axis, and the outer carrier is a stator fixedly attached to the housing.

26. The electric machine of claim 1, wherein the inner carrier comprises an inner carrier shaft, and wherein the auxiliary module is located within a cavity within the inner carrier shaft.

27. (canceled)

28. The electric machine of claim 1, wherein the auxiliary module is coupled to the inner and outer carriers.

29. (canceled)

30. A sub-assembly for a radial flux electric machine comprising:
a housing;
an inner carrier having an inner surface; and
an outer carrier radially spaced apart from the inner carrier by an airgap;
wherein the inner carrier is a first one of: a stator fixedly attached to the housing, and a rotor configured to rotate relative to the stator about an axis, and the outer carrier is the other one of: the stator fixedly attached to the housing, and the rotor configured to rotate relative to the stator about an axis;
a plurality of electromagnetic elements defining magnetic poles, disposed on the rotor or stator so as to generate a radial flux between the rotor and stator as the rotor rotates; and
wherein the ratio of the inner diameter of the outer carrier to the outer diameter of the outer carrier is at least 0.6; and
wherein the ratio of the inner diameter of the inner carrier to the outer diameter of the inner carrier is at least 0.6.
